(19) United States
(12) Patent Application Publication
(10) Pub. No.: US 2026/0186658 A1
(43) Pub. Date: Jul. 2, 2026

(54) STORAGE DEVICE, OPERATING METHOD THEREOF, AND STORAGE SYSTEM INCLUDING THE SAME

(71) Applicant: Samsung Electronics Co., Ltd., Suwon-si (KR)

(72) Inventors: Hyunwoo PARK, Suwon-si (KR); Heesung YANG, Suwon-si (KR); Yangwoo ROH, Suwon-si (KR); Yunho YANG, Suwon-si (KR)

(73) Assignee: Samsung Electronics Co., Ltd., Suwon-si (KR)

(21) Appl. No.: 19/238,957

(22) Filed: Jun. 16, 2025

(30) Foreign Application Priority Data
Dec. 26, 2024 (KR) 10-2024-0197347

(51) Int. Cl. G06F 3/06

(52) U.S. Cl. CPC G06F 3/0611; G06F 3/0659; G06F 3/0679

(57) ABSTRACT

A storage device according to some example embodiments may comprise a memory device, and a storage controller including a first mapping table and a second mapping table, the first mapping table including first mapping information between logical block addresses and placement identifiers, and the second mapping table including second mapping information between logical block addresses and physical block addresses, the storage controller configured to receive a first command including a first logical block address from a host device, identify a first placement identifier corresponding to the first logical block address based on the first mapping table, determine a first physical block address of the memory device associated with the first logical block address based on the first placement identifier, and update third mapping information between the first logical block address and the first physical block address in the second mapping table.

### CROSS-REFERENCE TO RELATED APPLICATION

This application claims priority under 35 U.S.C. § 119 to Korean Patent Application No. 10-2024-0197347, filed on Dec. 26, 2024, in the Korean Intellectual Property Office, the disclosure of which is incorporated herein by reference in its entirety.

### BACKGROUND

### Field

Some example embodiments of the present inventive concepts relate to storage devices, operating methods thereof, and/or storage systems including the same.

### Description of Related Art

A storage device is a device that stores data under the control of a host device such as a computer, a smartphone, and/or a smart pad. The storage device may include devices that store data on magnetic disks, such as hard disk drives HDDs, and devices that store data on semiconductor memory, for example, non-volatile memory, such as solid state drives SSDs and memory cards.

When data is continuously stored in the non-volatile memory of a storage device, it may be advantageous to perform garbage collection to move valid pages of at least one memory block to another memory block and perform an erase operation on the memory block in order to secure a free memory block. The free memory block may be a storage space where data may be written. However, every time garbage collection is performed, there may be a problem in that data processing speed may be delayed and/or the lifespan of the storage device is reduced.

The above-described information is intended to enhance understanding of the background of the present inventive concepts.

### SUMMARY

Some example embodiments relate to storage devices, operating methods thereof, and/or storage systems including the same for solving the above-mentioned problems.

However, the problems to be solved by some example embodiments of the present inventive concepts are not limited to those described above, and other problems not mentioned may be clearly understood by those skilled in the art from the description of the disclosure below.

According to some example embodiments, a storage device may include a memory device, and a storage controller including a first mapping table and a second mapping table, the first mapping table including first mapping information between logical block addresses and placement identifiers, and the second mapping table including second mapping information between the logical block addresses and physical block addresses, the storage controller configured to receive a first command including a first logical block address from a host device, identify a first placement identifier corresponding to the first logical block address based on the first mapping table, determine a first physical block address of the memory device associated with the first logical block address based on the first placement identifier, and update third mapping information between the first logical block address and the first physical block address in the second mapping table.

According to some example embodiments, a method of operating a storage device may include receiving, by a storage controller, a first command including a first logical block address from a host device, identifying, by the storage controller, a first placement identifier corresponding to the first logical block address based on a first mapping table including first mapping information between logical block addresses and placement identifiers, determining, by the storage controller, a first physical block address of a memory device associated with the first logical block address based on the first placement identifier, and updating, by the storage controller, second mapping information between the first logical block address and the first physical block address in a second mapping table that includes third mapping information between the logical block addresses and physical block addresses.

According to some example embodiments, a storage system may include a host device, and a storage device configured to perform a command received from the host device, the storage device including a memory device, and a storage controller including a first mapping table and a second mapping table, the first mapping table including first mapping information between logical block addresses and placement identifiers, and the second mapping table including second mapping information between the logical block addresses and physical block addresses, the storage controller configured to receive a first command including a first logical block address from the host device, identify a first placement identifier corresponding to the first logical block address based on the first mapping table, determine a first physical block address of the memory device associated with the first logical block address based on the first placement identifier, and update third mapping information between the first logical block address and the first physical block address in the second mapping table.

According to some example embodiments, a storage controller comprises at least one processor; and at least one memory storing instructions that, when executed by the at least one processor, is configured to cause the storage controller to, receive a first command including a first logical block address from a host device; identify a first placement identifier corresponding to the first logical block address based on a first mapping table; determine a first physical block address of a memory device associated with the first logical block address based on the first placement identifier; and update first mapping information between the first logical block address and the first physical block address in a second mapping table.

In some example embodiments, the first mapping table comprises a plurality of entries, the plurality of entries storing second mapping information between logical addresses and placement identifiers, and ranges of the logical block addresses associated with each entry of the plurality of entries are different from each other.

In some example embodiments, the storage controller is further caused to receive a second command from the host device, and the second command is a table management command for managing the first mapping table.

In some example embodiments, the storage controller is further caused to send information associated with the plurality of entries comprised in the first mapping table to the host device in response to receiving the second command.

According to some example embodiments, a first mapping table including mapping information between logical block addresses and placement identifiers is included in a storage device other than a host device, and a placement identifier associated with a physical block address for storing data may be determined by a storage controller. Accordingly, compared to an example where a host device specifies a placement identifier and transmits the specified placement identifier to a storage device, the need for modifications to a plurality of layers within a host software stack may be minimized, thereby effectively reducing the complexity of system implementation and the burden of maintenance.

According to some example embodiments, unnecessary garbage collection operations may be suppressed by including a first mapping table in a storage device for comprehensively managing user data having a similar range of expected lifetimes.

According to some example embodiments, a storage device may optimize a storage pattern of user data stored in the storage device by performing table management commands for managing a first mapping table including mapping information between logical block addresses and placement identifiers.

The effects that may be obtained through some example embodiments of the present inventive concepts are not limited to those described above. Any other example embodiments not mentioned will be clearly understood by those skilled in the art from the description of the disclosure set forth below.

### BRIEF DESCRIPTION OF THE DRAWINGS

FIG. 1 is a diagram illustrating a storage system according to some example embodiments.

FIG. 2 is a diagram illustrating a nonvolatile memory according to some example embodiments.

FIG. 3 is a conceptual diagram illustrating the structure of data stored in a memory device according to some example embodiments.

FIG. 4 is a conceptual diagram illustrating an example of performing flexible data placement (FDP) according to some example embodiments.

FIG. 5 is a diagram illustrating a storage device according to some example embodiments.

FIG. 6 is a diagram illustrating an example of a first mapping table according to some example embodiments.

FIG. 7 is a diagram illustrating an example of a second mapping table according to some example embodiments.

FIG. 8 is a flowchart illustrating an example of how a write command is performed according to some example embodiments.

FIG. 9 is a diagram illustrating an example of performing a write command according to some example embodiments.

FIG. 10 is a diagram illustrating an example of performing a write command according to some example embodiments.

FIG. 11 is a diagram illustrating an example of performing a write command according to some example embodiments.

FIG. 12 is a diagram illustrating an example of performing a write command according to some example embodiments.

FIG. 13 is a diagram illustrating an example of performing a write command according to some example embodiments.

FIG. 14 is a flowchart illustrating an example of how a table management command is performed according to some example embodiments.

FIG. 15 is a diagram illustrating an example of performing a table management command according to some example embodiments.

FIG. 16 is a diagram illustrating an example of performing a table management command according to some example embodiments.

FIG. 17 is a diagram illustrating an example of performing a table management command according to some example embodiments.

### DETAILED DESCRIPTION

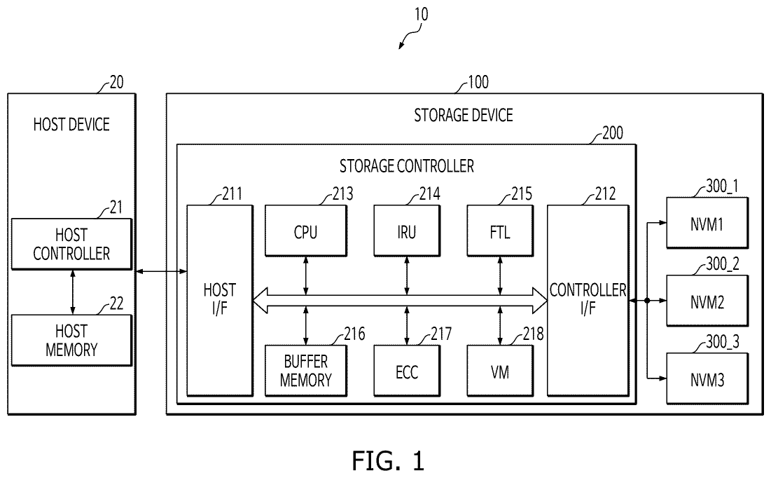

Hereinafter, various example embodiments of the present inventive concepts will be described with reference to FIGS. 1 to 17. Throughout the specification, the same reference numerals may refer to the same components.

FIG. 1 is a drawing showing a storage system 10 according to some example embodiments. Referring to FIG. 1, a storage system 10 may include a host device 20 and a storage device 100. The host device 20 and the storage device 100 may transmit and/or send and receive data and/or signals to and from each other.

The host device 20 may include a host controller 21 and a host memory 22. The host memory 22 may function as a buffer memory for temporarily storing data to be transmitted and/or sent to the storage device 100 or data transmitted and/or sent from the storage device 100.

According to some example embodiments, the host controller 21 and the host memory 22 may be implemented as separate semiconductor chips, but example embodiments are not limited thereto. In some example embodiments, the host controller 21 and the host memory 22 may be integrated into the same semiconductor chip. For example, the host controller 21 may be any one of a plurality of modules provided in an application processor, and the application processor may be implemented as a system on chip (SoC). In some example embodiments, the host memory 22 may be an embedded memory provided within the application processor, or a volatile memory and/or a memory module disposed outside the application processor.

In some example embodiments, the host controller 21 may manage an operation of storing data of the host memory 22 in nonvolatile memory devices 300_1 to 300_3 through the storage controller 200, or storing data of the memory devices 300_1 to 300_3 in the host memory 22 through the storage controller 200.

The host controller 21 may generate commands (e.g., read commands, write commands, TRIM commands, table management commands, etc.) to be executed in the storage device 100, and store (e.g., queue) them in the host memory 22.

The storage device 100 may include a storage controller 200 and a plurality of nonvolatile memory devices NVMs 300_1 to 300_3. The storage controller 200 and each of the plurality of nonvolatile memory devices 300_1 to 300_3 may transmit and/or send and receive data, signals, etc., to and from each other. Although three nonvolatile memory devices 300_1 to 300_3 are illustrated in FIG. 1, example embodiments are not limited thereto, and any number of memory devices may be included in the storage device 100. For example, the storage device 100 may include a plurality of memory devices connected and arranged in an array form.

The storage device 100 may include a storage medium for storing data upon request from a host device 20. For example, the storage device 100 may include at least one of a solid state drive (SSD), an embedded memory, and/or a removable external memory. In some example embodiments, if the storage device 100 is an SSD, the storage device 100 may be a device that follows the nonvolatile memory express (NVMe) standard. In some example embodiments, if the storage device 100 is an embedded memory and/or an external memory, the storage device 100 may be a device that follows the universal flash storage (UFS) or embedded multi-media card (eMMC) standard. The host device 20 and the storage device 100 may each generate packets according to the adopted standard protocol and transmit and/or send them.

In some example embodiments, when the nonvolatile memory devices 300_1 to 300_3 include flash memory, the flash memory may include a 2D NAND memory array or a 3D, vertical and/or bonding vertical NAND (VNAND) memory array. In some example embodiments, the storage device 100 may include various other types of nonvolatile memory and/or volatile memory. For example, the storage device 100 may include at least one of volatile or nonvolatile memories, such as static RAM (SRAM), dynamic RAM (DRAM), synchronous DRAM (SDRAM), read only memory (ROM), programmable ROM (PROM), electrically programmable ROM (EPROM), electrically erasable and programmable ROM (EEPROM), magnetic RAM (MRAM), spin-transfer torque MRAM, conductive bridging RAM (CBRAM), ferroelectric RAM (FeRAM), phase RAM (PRAM), and/or resistive RAM, but example embodiments are not limited thereto. For example, at least some of the plurality of nonvolatile memory devices 300_1 to 300_3 may alternatively be volatile memory devices.

The storage controller 200 may include a host interface 211, a controller interface 212, and a central processing unit (CPU) 213. In some example embodiments, the storage controller 200 may further include an index read unit (IRU) 214, a flash translation layer (FTL) 215, a buffer memory 216, an error correction code (ECC) 217 engine, and an internal volatile memory (VM) 218. The storage controller 200 may further include a working memory into which the flash translation layer 215 is loaded, and data write and read operations for nonvolatile memory may be controlled by the CPU 213 executing the flash translation layer 215. As described herein, any devices, electronic devices, modules, units, and/or portions thereof according to any of the example embodiments, and/or any portions thereof (including, without limitation, the storage controller 200, the host interface 211, the controller interface 212, the CPU 213, the IRU 214, the FTL 215, the buffer memory 216, the ECC 217 engine, and/or the internal volatile memory 218) may include, may be included in, and/or may be implemented by one or more instances of processing circuitry such as hardware including logic circuits; a hardware/software combination such as a processor executing software; or a combination thereof. In some example embodiments, the processing circuitry may include a non-transitory computer readable storage medium (e.g., a memory), for example a solid state drive (SSD), storing a program of instructions, and a processor configured to execute the program of instructions to implement the functionality and/or methods performed by some or all of any devices, electronic devices, modules, units, and/or portions thereof according to any of the example embodiments.

The host interface 211 may transmit and/or send and receive packets to and from the host device 20. A packet transmitted and/or sent from the host device 20 to the host interface 211 may include a command and/or data to be written to and/or transmitted and/or sent to nonvolatile memory devices 300_1 to 300_3, and a packet transmitted and/or sent from the host interface 211 to the host device 20 may include a response to a command, data which is read from nonvolatile memory devices 300_1 to 300_3, and the like. The host interface 211 is illustrated as being included in the storage controller 200, but example embodiments are not limited thereto. For example, in some example embodiments, the host interface 211 may be located outside (e.g., external to) the storage controller 200.

The controller interface 212 may transmit and/or send data to be written to the nonvolatile memory devices 300_1 to 300_3 to the nonvolatile memory devices 300_1 to 300_3 and/or receive data which is read from the nonvolatile memory devices 300_1 to 300_3. The controller interface 212 may be implemented to comply with standard protocols such as Toggle or Open NAND Flash Interface (ONFI).

The flash translation layer 215 may perform various functions such as address mapping, wear-leveling, and garbage collection. For example, the flash translation layer 215 may determine a physical block address corresponding to a logical block address from the logical block address. In some example embodiments, the flash translation layer 215 may manage a mapping table containing mapping information between the logical block address and the physical block address.

The buffer memory 216 may temporarily store data to be written to the memory devices 300_1 to 300_3 or data which is read from the nonvolatile memory devices 300_1 to 300_3. The buffer memory 216 may be configured to be provided within the storage controller 200, but may also be disposed outside (e.g., external to) the storage controller 200.

The ECC engine 217 may perform error detection and correction functions for read data which is read from nonvolatile memory devices 300_1 to 300_3. For example, the ECC engine 217 may generate a parity bit for write data to be written to the nonvolatile memory devices 300_1 to 300_3, and the parity bit generated in this way may be stored in the nonvolatile memory devices 300_1 to 300_3 together with the write data. In some example embodiments, when reading data from the nonvolatile memory devices 300_1 to 300_3, the ECC engine 217 may correct errors in the read data using parity bits which are read from the nonvolatile memory devices 300_1 to 300_3 together with the read data, and may output the read data with the errors corrected.

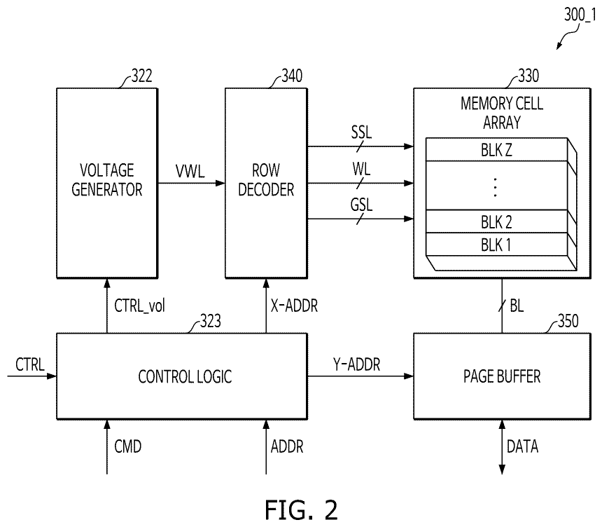

FIG. 2 is a diagram illustrating a nonvolatile memory according to some example embodiments. Although each of the components of FIG. 2 is illustrated and described as being included in one nonvolatile memory device 300_1 of FIG. 1, it should be understood that example embodiments are not limited thereto, and, in some examples, each of the components described with reference to FIG. 2 may be applied to any nonvolatile memory device connected to the storage controller 200 of FIG. 1.

Referring to FIG. 2, the nonvolatile memory device 300_1 may include a memory cell array 330, a voltage generator 322, a control logic circuit 323, a row decoder 340, and a page buffer circuit 350. In some example embodiments, the nonvolatile memory device 300_1 may further include a data input/output circuit and/or an input/output interface.

The memory cell array 330 includes a plurality of memory cells and may be connected to word lines WL, string selection lines SSL, ground selection lines GSL, and a plurality of bit lines BL. For example, the memory cell array 330 may be connected to the row decoder 340 through word lines WL, string select lines SSL, and ground select lines GSL, and may be connected to the page buffer circuit 350 through a plurality of bit lines BL.

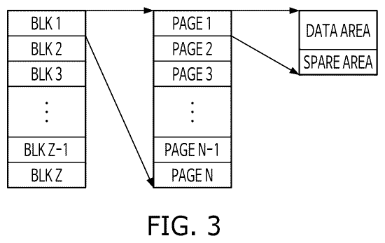

The memory cell array 330 may include a plurality of memory blocks BLK 1 to BLK Z. Each of the plurality of memory blocks BLK 1 to BLK Z may include a plurality of pages in which memory cells are connected. Each word line WL may be associated with one or more pages. An example of a plurality of memory blocks BLK 1 to BLK Z containing a plurality of pages is described in detail below with reference to FIG. 3.

Each of the plurality of memory blocks BLK 1 to BLK Z may have a three-dimensional structure or vertical structure. For example, each memory block BLK 1 to BLK Z includes structures extending along the first to third directions. For example, each memory block BLK 1 to BLK Z includes a plurality of NAND strings extending along a third direction. In some example embodiments, a plurality of NAND strings may be provided spaced apart by a specific or alternatively, a desired distance along the first and second directions.

The plurality of memory blocks BLK 1 to BLK Z may be selected by the row decoder 340. For example, the row decoder 340 may select a memory block corresponding to a block address among the plurality of memory blocks BLK 1 to BLK Z.

Each of the plurality of memory blocks BLK 1 to BLK Z may correspond to a specific logic block accessed by a storage controller (e.g., storage controller 200) in FIG. 1. For example, one logic block may correspond to at least one physical memory block among the plurality of memory blocks BLK 1 to BLK Z. The flash translation layer (e.g., FTL 215 in FIG. 1) of the storage controller (e.g., storage controller 200 in FIG. 1) manages the mapping relationship between logic blocks and the plurality of memory blocks BLK 1 to BLK Z, and may access the plurality of memory blocks BLK 1 to BLK Z using the logic blocks.

In some example embodiments, when an erase voltage is applied to the memory cell array 330, a plurality of memory cells are in an erased state, and when a program voltage is applied to the memory cell array 330, a plurality of memory cells may be in a program state. For example, each memory cell may have an erased state or at least one program state distinguished by a threshold voltage. For example, the states of the memory cell may include an erased state and at least one program state, and a specific state of each memory cell may be an erased state or one of at least one program state.

The control logic circuit 323 may generally control various operations within the nonvolatile memory device 300_1. For example, the control logic circuit 323 may output various control signals for writing data to or reading data from the memory cell array 330 based on a command CMD, an address ADDR, and a control signal CTRL. The control logic circuit 323 may control a plurality of program operations to be performed for a plurality of pages.

Various control signals, which are output from the control logic circuit 323, may be provided to the voltage generator 322, the row decoder 340, and the page buffer circuit 350. For example, the control logic circuit 323 may provide a voltage control signal CTRL_vol to the voltage generator 322.

The voltage generator 322 may be connected to the memory cell array 330 through a plurality of word lines WL. The voltage generator 322 may generate various types of voltages for performing a program operation, a read operation, and/or an erase operation on the memory cell array 330 based on a voltage control signal CTRL_vol. The voltage generator 322 may generate word line voltages VWL, for example, a program voltage, a verification voltage, a read voltage, an erase voltage, etc.

The program voltage, verification voltage, read voltage, erase voltage, etc., generated by the voltage generator 322 may be provided to a selected word line among a plurality of word lines WL. The selected word line may be at least one word line selected by a row address X-ADDR. Each of the plurality of word lines WL includes a plurality of pages, and program operations, verification operations, read operations, etc., performed by voltages generated by the voltage generator 322 may be performed on a page basis. For example, a program voltage (or pulse) and a verification voltage (or pulse) may be applied to a selected page within a selected word line, thereby performing program and verification operations on the selected page.

In some example embodiments, during an erase operation, the voltage generator 322 may apply an erase voltage to the well and/or common source line of the memory block. In some example embodiments, the voltage generator 322 may apply an erase allowable voltage (e.g., ground voltage) to all word lines WL of the memory block or word lines corresponding to some sub-blocks based on the erase address. In some example embodiments, during an erase verification operation, the voltage generator 322 may apply an erase verify voltage to all word lines WL of one memory block or apply an erase verification voltage per word line.

In some example embodiments, during program operation, the voltage generator 322 may apply a program voltage to a selected word line among a plurality of word lines WL and apply a program pass voltage to unselected word lines among a plurality of word lines WL. In some example embodiments, during a program verification operation, the voltage generator 322 may apply a program verification voltage to selected word lines and apply a verification pass voltage to unselected word lines.

In some example embodiments, during a normal read operation, the voltage generator 322 may apply a read voltage to a selected word line and apply a read pass voltage to unselected word lines.

In some example embodiments, during a data recovery read operation, the voltage generator 322 may apply a read pass voltage to a selected word line and apply a read voltage to at least one word line adjacent to the selected word line. In some example embodiments, the voltage generator 322 may apply a read voltage to the selected word line and apply a read voltage to at least one word line adjacent to the selected word line.

The row decoder 340 may select a specific or alternatively, a desired word line among the word lines WL in response to a row address X-ADDR received from the control logic circuit 323. For example, during program operation, the row decoder 340 may provide a program voltage to a selected word line. In some example embodiments, the row decoder 340 may select some of the string select lines SSL or some of the ground select lines GSL in response to the row address X-ADDR received from the control logic circuit 323.

The page buffer circuit 350 may be connected to the memory cell array 330 through a plurality of bit lines BL. The page buffer circuit 350 may select some bit lines among a plurality of bit lines BL in response to a column address Y-ADDR received from the control logic circuit 323. In some example embodiments, during a verification operation (e.g., an erase verification operation and/or a program verification operation) or a read operation, the page buffer circuit 350 may act as a sense amplifier to sense data stored in a selected memory cell through a selected bit line. In some example embodiments, when the program is operating, the page buffer circuit 350 may operate as a write driver to input data to be stored in the memory cell array 330. The page buffer circuit 350 may include a plurality of page buffers. For example, each page buffer may be connected to at least one bit line.

The page buffer circuit 350 may store data which is read from the memory cell array 330 and/or store data to be stored in the memory cell array 330.

The page buffer circuit 350 may include a plurality of page buffers each connected to a plurality of bit lines BL. A plurality of page buffers may be arranged corresponding to each bit line, and each page buffer may include a plurality of latches. According to some example embodiments, the page buffer circuit 350 will be defined as including a page buffer connected to each bit line. However, example embodiments of the present inventive concepts may define the term differently, and in some example embodiments, a unit of configuration, in which one page buffer is provided to correspond to a plurality of bit lines and is arranged to correspond to each bit line, may be defined as a page buffer unit. The page buffer circuit 350 may temporarily store data to be programmed in a selected page during a program operation and temporarily store data which is read from a selected page during a read operation.

The control logic circuit 323, the voltage generator 322, the row decoder 340, and the page buffer circuit 350 may be included in the peripheral circuit.

FIG. 3 is a conceptual diagram illustrating the structure of data stored in a memory device according to some example embodiments. A memory cell array (e.g., memory cell array 330 in FIG. 2) included in a memory device may include a plurality of memory blocks BLK 1 to BLK Z. Each of the plurality of memory blocks BLK 1 to BLK Z may include a plurality of pages PAGE 1 to PAGE N, and each page may include a plurality of memory cells connected to a plurality of word lines.

The memory cells may contain at least one transistor, which may store data by storing electrons. Each of the memory cells may store at least one bit. In some example embodiments, the memory cell may be a single level cell (SLC) which stores one bit of data. In some example embodiments, the memory cell may be a multi-level cell (MLC) that stores more than two bits of data, such as an MLC (or a double level cell) that stores two bits of data, a triple level cell (TLC) that stores three bits of data, and/or a quadruple level cell (QLC) that stores four bits of data. However, example embodiments are not limited thereto.

In some example embodiments, read operations and/or write operations performed by a storage device (e.g., storage device 100 of FIG. 1) may be performed on a page-by-page basis. In some example embodiments, the erase operation may be performed on a memory block basis. In some example embodiments, data (e.g., user data) entered into a storage device (e.g., storage device 100 of FIG. 1) may be stored in a valid page or a free page existing in at least one of the plurality of memory blocks BLK 1 to BLK Z of the memory device.

A page may be divided into a data area where data is stored and a spare area where no data is stored. For example, the data area may be allocated 2 kilobytes, the spare area may be allocated 64 bytes, but example embodiments are not limited thereto.

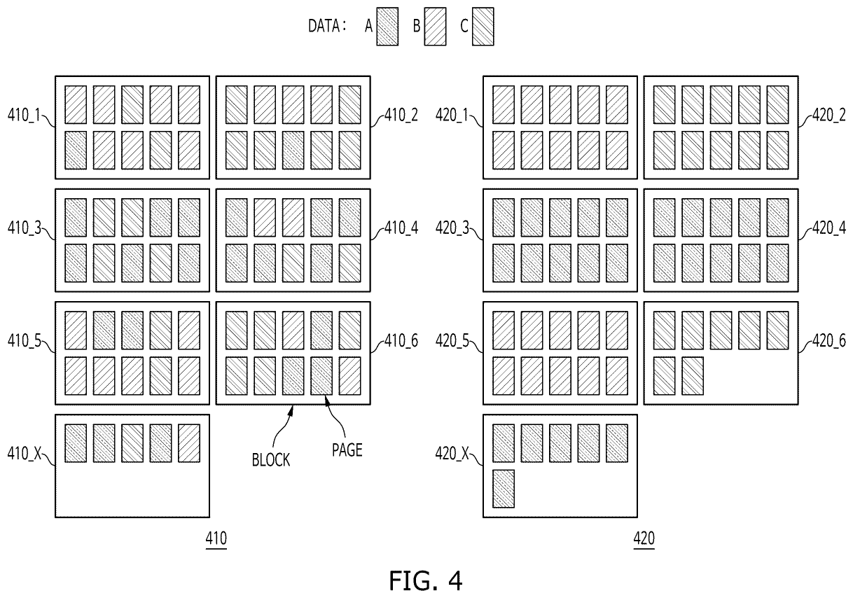

FIG. 4 is a conceptual diagram illustrating an example of performing flexible data placement (FDP) according to some example embodiments. A memory device may include a plurality of memory blocks, and each of the plurality of memory blocks may include a plurality of pages having memory cells connected thereto.

A storage controller may receive a write command for storing user data from a host device, and determine a physical block address of the memory device for storing the user data based on the received write command. The memory device may store user data in a specific or alternatively, a desired page of a specific or alternatively, a desired memory block corresponding to a determined physical block address. For convenience of explanation, it is assumed that the user data associated with one write command is stored in one page.

The storage controller may perform a plurality of write commands. For example, the storage controller may perform a first type of write command, a second type of write command, and a third type of write command concurrently or sequentially. In some example embodiments, the expected lifetime of user data A associated with the first type of write command, the expected lifetime of user data B associated with the second type of write command, and the expected lifetime of user data C associated with the third type of write command may fall within different ranges. According to some example embodiments, lifetime and/or expected lifetime may mean the expected time of from a time when data is stored to a time when the data is deleted, or the change cycle of the data. For example, the expected lifetime of the user data A associated with the first type of write command belongs to a first range of time/period, the expected lifetime of the user data B associated with the second type of write command belongs to a second range of time/period, and the expected lifetime of the user data C associated with the third type of write command belongs to a third range of time/period, and, in some example embodiments, the first to third ranges may be different from each other.

Still referring to FIG. 4, a first example 410 is an example in which a write command is performed in a state in which FDP is not performed. Referring to the first example 410, each of the user data A, B and C associated with the first to third types of write commands may be stored scattered across a plurality of memory blocks 410_1 to 410_X. For example, if FDP is not performed, the expected lifetime of each of user data A, B and C is not considered during the execution of the write command, so the plurality of user data A, B and C with expected lifetimes in different ranges may be stored in one memory block.

In some example embodiments, the write operation to store user data A, B and C may be performed in units of pages, while the erase operation to delete user data A, B and C may be performed in units of memory blocks. In some example embodiments, even if only the user data (e.g., user data A) associated with one type of write command is deleted, the user data (e.g., user data B or user data C) associated with other types of write commands stored in the same memory block as the user data may also be invalidated, so it would be advantageous to perform a garbage collection operation to move the user data (e.g., user data B or user data C) to other memory blocks. As garbage collection operations are repeated, the program/erase (P/E) cycles of the memory device increase, which may result in unnecessary and/or an increase in power consumption and delays in data processing speed. Accordingly, the lifespan of the memory device may also be negatively affected. For example, the lifespan of the memory device may be reduced.

The second example 420 is an example in which a write command is performed while FDP is being performed. Referring to the second example 420, user data A, B and C associated with the first to third types of write commands may be stored separately in a plurality of memory blocks 420_1 to 420_X. For example, user data with different expected lifetimes may be stored in different memory blocks. For example, the storage pattern of user data A, B and C stored in the plurality of memory blocks 420_1 to 420_X may be optimized to minimize and/or reduce garbage collection operations.

Hereinafter, a device and/or method for comprehensively managing a plurality of user data A, B and C having similar ranges of lifetimes according to some example embodiments are described in order to suppress, mitigate, and/or reduce unnecessary and/or undesirable garbage collection operations.

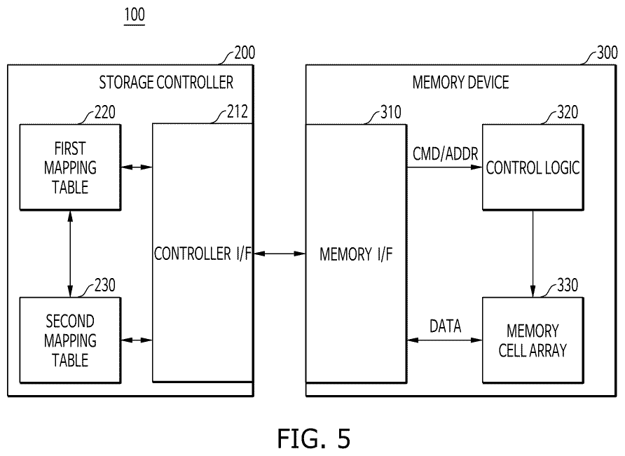

FIG. 5 is a diagram illustrating a storage device 100 according to some example embodiments. The storage device 100 may include a memory device 300 and a storage controller 200 configured to control the memory device 300. In FIG. 5, descriptions overlapping with those in FIGS. 1 and 2 are omitted.

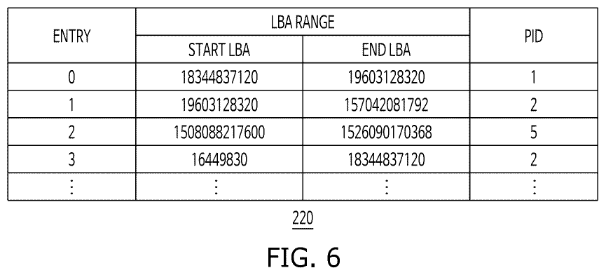

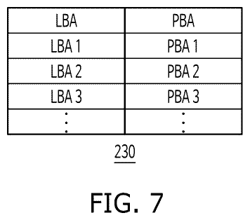

The storage controller 200 may include a controller interface 212, a first mapping table 220, and a second mapping table 230. The first mapping table 220 may include mapping information between logical block addresses and placement identifiers. For example, the first mapping table 220 may be a logical block address to placement identifier (LBA-to-PID) mapping table. The second mapping table 230 may include mapping information between logical block addresses and physical block addresses. For example, the second mapping table 230 may be a logical block address to physical block address (LBA-to-PBA) mapping table. An example for the first mapping table 220 according to some example embodiments is described below with reference to FIG. 6, and an example for the second mapping table 230 according to some example embodiments is described below with reference to FIG. 7.

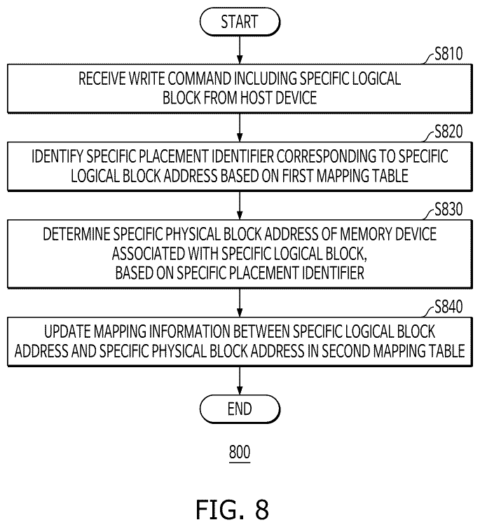

The storage controller 200 receives a command from a host device (e.g., host device 20 of FIG. 1) and may store or read data in the memory device 300 based on the first mapping table 220 and/or the second mapping table 230. For example, the storage controller 200 may receive a write command from the host device (e.g., host device 20 of FIG. 1) to store data (e.g., user data) in the memory device 300. The write command may include data and a logical block address to be stored in the memory device 300. The storage controller 200 may determine a physical block address for storing data based on the first mapping table 220 and/or the second mapping table 230, and transmit and/or send a memory device command to the memory device 300 to instruct the memory device 300 to store data at the determined physical block address. In some example embodiments, the storage controller 200 may update the second mapping table 230 based on the determined physical block address. According to some example embodiments, at least some of these actions and/or operations may be performed, for example, by an FTL (e.g., FTL 215 in FIG. 1). In some example embodiments, data to be stored in the memory device 300 and/or memory device commands may be transmitted and/or sent to the memory device 300 via the controller interface 212. Some examples of how the write command is performed are described in detail below with reference to FIGS. 8 to 13 according to some example embodiments.

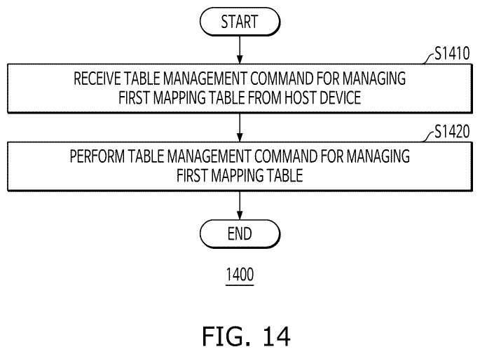

In some example embodiments, the storage controller 200 may receive a table management command for managing the first mapping table 220 from the host device (e.g., host device 20 of FIG. 1). The storage controller 200 may perform tasks associated with the first mapping table 220 based on table management commands. Some examples of the execution of table management commands are described in detail below with reference to FIGS. 14 to 17 according to some example embodiments.

The memory device 300 may include a memory interface 310, a control logic 320, and a memory cell array 330. The memory device 300 may correspond to one of the nonvolatile memory devices 300_1 to 300_3 according to some example embodiments that communicate with the storage controller 200 of FIG. 1.

The memory interface 310 may provide an interface between the memory device 300 and the storage controller 200. For example, the memory device 300 may receive a command CMD, an address ADDR, and/or data DATA from the storage controller 200 through the memory interface 310, or transmit and/or send data DATA stored in the memory cell array 330 to the storage controller 200. In some example embodiments, data DATA is user data to be stored in the memory device 300, the address ADDR is associated with a physical block address of the memory device 300 determined by the storage controller 200, and the command CMD may be a memory device command that instructs to store data in the determined physical block address.

The control logic 320 may control various operations of the memory device 300 in general. The control logic 320 may receive a command/address CMD/ADDR transmitted and/or sent through the memory interface 310. The control logic 320 may generate control signals for controlling other components of the memory device 300 based on the received command/address CMD/ADDR. For example, the control logic 320 may generate various control signals for storing data DATA in the memory cell array 330 and/or reading data DATA from the memory cell array 330. In some example embodiments, control signals may be generated to adjust the channel potential within the memory cell array 330.

The memory cell array 330 may store data DATA received through the memory interface 310 under the control of the control logic 320. The memory cell array 330 may output data DATA stored in the memory cell array 330 to the memory interface 310 under the control of the control logic 320. In some example embodiments, the channel potential within the memory cell array 330 may be adjusted under the control of the control logic 320.

The memory cell array 330 may include a plurality of memory cells. For example, the plurality of memory cells may be flash memory cells. However, example embodiments of the present inventive concepts are not limited thereto, and, in some example embodiments, the memory cells may be resistive random access memory (RRAM) cells, ferroelectric random access memory (FRAM) cells, phase change random access memory (PRAM) cells, thyristor random access memory (TRAM) cells, and/or magnetic random access memory (MRAM) cells. Hereinafter, some example embodiments will be described focusing on examples in which the memory cells are NAND flash memory cells.

Although FIG. 5 illustrates a memory device 300 including a memory interface 310, a control logic 320, and a memory cell array 330, example embodiments of the present inventive concepts are not limited thereto, and, in some example embodiments, the memory device 300 may further include components that perform various functions.

Still referring to FIG. 5, in some example embodiments, the first mapping table 220 including mapping information between logical block addresses and placement identifiers is included in a storage device 100 rather than a host device (e.g., host device 20 of FIG. 1), and a placement identifier associated with a physical block address for storing data may be determined by the storage controller 200. Accordingly, compared to some example embodiments where a host device (e.g., host device 20 of FIG. 1) specifies a placement identifier and transmits and/or sends it to the storage device 100, modifications to a plurality of layers within the host software stack may be minimized and/or reduced, thereby effectively reducing the complexity of system implementation and the burden of maintenance.

FIG. 6 is a diagram illustrating an example of a first mapping table 220 according to some example embodiments. A storage controller (e.g., storage controller 200 of FIG. 5) may include the first mapping table 220.

The first mapping table 220 may include a plurality of entries. The plurality of entries may store mapping information between logical block addresses and placement identifiers. For example, each of the plurality of entries may store information about a logical block address and a placement identifier assigned to the logical block address. The plurality of entries may be assigned an identification number (e.g., 0, 1, 2, 3) to identify each entry.

In some example embodiments, a logical block address in the first mapping table 220 may be expressed as a range of logical block addresses LBA RANGE. For example, the plurality of entries may store a start logical block address START LBA and an end logical block address END LBA to define the range of each logical block address. In some example embodiments, the plurality of entries may store the start logical block address (or the end logical block address) and a length of the logical block address (e.g., the length from the start logical block address to the end logical block address) to define the range of each logical block address. The range of logical block addresses associated with each of the plurality of entries may be defined differently within non-overlapping ranges, but example embodiments are not limited thereto.

In some example embodiments, mapping information between logical block addresses and placement identifiers included in the first mapping table 220 may be associated with the expected lifetime of user data stored at each logical block address. For example, user data with different expected lifetimes may be associated with different placement identifiers, but example embodiments are not limited thereto.

The storage controller (e.g., storage controller 200 of FIG. 5) may perform a write command received from a host device based on the first mapping table 220. For example, the storage controller (e.g., storage controller 200 of FIG. 5) may identify a placement identifier corresponding to a logical block address included in a write command based on the first mapping table 220, and determine a physical block address of the memory device (e.g., memory device 300 of FIG. 5) corresponding to the logical block address based on the identified placement identifier. In some example embodiments, the storage controller (e.g., storage controller 200 of FIG. 5) may determine the physical block address of the memory device (e.g., memory device 300 of FIG. 5) based on the identified placement identifier and logical block address.

The storage controller (e.g., storage controller 200 of FIG. 5) may receive a table management command from the host device and perform the table management command to manage the first mapping table 220. In some example embodiments, the storage controller (e.g., storage controller 200 of FIG. 5) may transmit and/or send information associated with the first mapping table 220 to the host device or change/delete mapping information included in the first mapping table 220, based on a table management command received from the host device. In some example embodiments, the storage controller (e.g., storage controller 200 of FIG. 5) may add new mapping information to the first mapping table 220.

In some example embodiments, one placement identifier may be assigned to one logical block address. In some example embodiments, a single placement identifier may be assigned to a plurality of logical block addresses. For example, a placement identifier assigned to correspond to the logical block address of the first entry and a placement identifier assigned to correspond to the logical block address of the third entry may be identical.

In FIG. 6, it is assumed that the storage controller (e.g., storage controller 200 of FIG. 5) includes one first mapping table 220, but example embodiments are not limited thereto. For example, if the storage controller (e.g., storage controller 200 of FIG. 5) manages a plurality of namespaces, the storage controller (e.g., storage controller 200 of FIG. 5) may include a plurality of first mapping tables 220 associated with each of the plurality of namespaces. For example, there may be at least one first mapping table 220 corresponding to each namespace. A plurality of first mapping tables 220 may represent mapping information between logical block addresses and placement identifiers for each of a plurality of namespaces.

In some example embodiments, when the storage controller (e.g., storage controller 200 of FIG. 5) includes a plurality of first mapping tables 220, a write command received from the host device may further include information associated with a namespace in which data is to be stored/written. For example, the write command may further include information to identify/allocate the namespace into which the data is to be written. For example, the logical block address included in the write command may mean the logical block address of a specific or alternatively, a desired namespace where data is to be written. Accordingly, the storage controller (e.g., storage controller 200 of FIG. 5) may identify the first mapping table 220 and/or a placement identifier corresponding thereto based on information associated with a namespace and a logical block address included in a write command, and determine a physical block address of the memory device (e.g., memory device 300 of FIG. 5) based on the identified first mapping table 220 and/or placement identifier.

In some example embodiments, when the storage controller (e.g., storage controller 200) includes a plurality of first mapping tables 220, a table management command received from the host device may include information associated with a specific or alternatively, a desired mapping table to be managed among the plurality of first mapping tables 220 and/or information on a namespace associated with the specific or alternatively, the desired mapping table to be managed. Accordingly, the storage controller (e.g., storage controller 200 of FIG. 5) may identify the specific or alternatively, desired mapping table corresponding to information associated with the specific or alternatively, desired mapping table included in a table management command and/or information about a namespace associated with the specific or alternatively, desired mapping table, and transmit and/or send information associated with the identified specific or alternatively, desired mapping table to a host device, or change/delete mapping information included in the identified specific or alternatively, desired mapping table.

FIG. 7 is a diagram illustrating an example of a second mapping table 230 according to some example embodiments. A storage controller (e.g., storage controller 200 in FIG. 5) may include a second mapping table 230. The second mapping table 230 may include mapping information between logical block addresses and physical block addresses.

The storage controller (e.g., storage controller 200 in FIG. 5) may perform a command (e.g., a read command, a write command, a trim command, etc.) received from a host device, based on the second mapping table 230.

For example, the second mapping table 230 may be used when the storage controller (e.g., storage controller 200 in FIG. 5) performs a read command. For example, the storage controller (e.g., storage controller 200 in FIG. 5) may identify a physical block address corresponding to a logical block address included in a read command based on the second mapping table 230. In some example embodiments, a memory device command to read data stored at the identified physical block address may be transmitted and/or sent by the storage controller (e.g., storage controller 200 in FIG. 5) to the memory device (e.g., memory device 300 in FIG. 5).

In some example embodiments, a second mapping table 230 may be used when the storage controller (e.g., storage controller 200 in FIG. 5) performs a write command. For example, the storage controller (e.g., storage controller 200 in FIG. 5) may identify a placement identifier corresponding to a logical block address included in a write command based on a first mapping table (e.g., first mapping table 220 of FIG. 6), and determine a physical block address associated with the logical block address based on the identified placement identifier. In some example embodiments, the storage controller (e.g., storage controller 200 in FIG. 5) may update mapping information between the logical block address and the determined physical block address in the second mapping table 230. The mapping information stored in the second mapping table 230 may be dynamically updated as various operations (e.g., commands) are performed by the storage controller (e.g., storage controller 200 in FIG. 5). In some example embodiments, the storage controller (e.g., storage controller 200 in FIG. 5) may determine a physical block address associated with a logical block address included in a write command based on the second mapping table 230.

In some example embodiments, the storage controller (e.g., storage controller 200 in FIG. 5) may check whether the corresponding mapping information is not registered in the second mapping table 230 before updating the second mapping table 230, but example embodiments are not limited thereto.

FIG. 8 is a flowchart illustrating an example of a method 800 by which a write command is performed according to some example embodiments. The method 800 may be performed by a storage controller (e.g., a storage controller of a storage device). The method 800 may be initiated by a storage controller receiving a write command including a specific or alternatively, a desired logical block address from a host device (S810). The storage controller may identify a specific or alternatively, a desired placement identifier corresponding to the specific or alternatively, desired logical block address based on the first mapping table (S820). In some example embodiments, the storage controller may determine a specific or alternatively, a desired physical block address of a memory device associated with the specific or alternatively, desired logical block address, based on the specific or alternatively, desired placement identifier (S830).

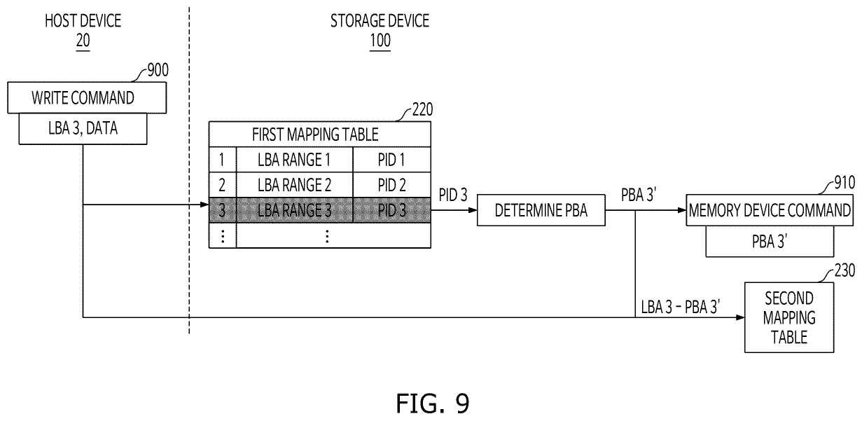

A write command may include user data to be stored in the memory device. A storage controller may send a memory device command to the memory device that instructs the memory device to store user data at a specific or alternatively, a desired physical block address. In some example embodiments, the storage controller may update mapping information between the specific or alternatively, desired logical block address and the specific or alternatively, desired physical block address in a second mapping table (S840). An example thereof is described below with reference to FIG. 9.

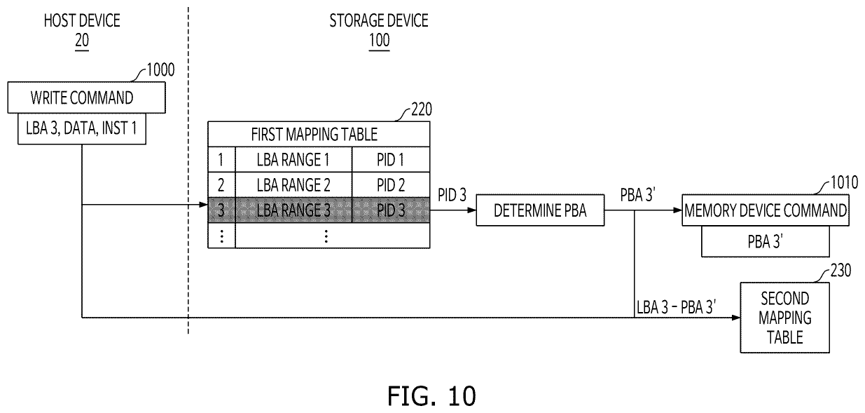

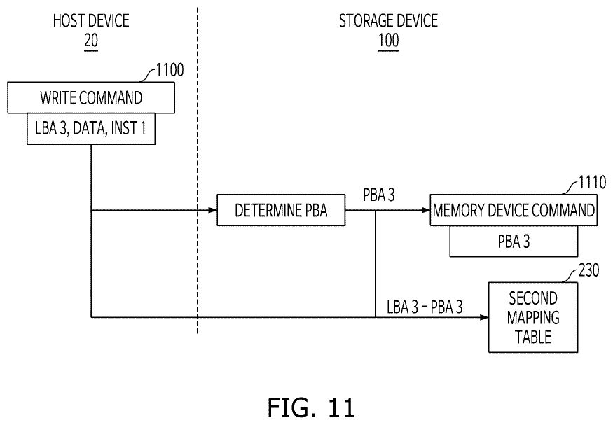

In some example embodiments, the write command may further include instruction data (e.g., first instruction data) indicating whether to refer to the first mapping table. The storage controller may determine whether to refer to the first mapping table to perform a write command, based on the instruction data. For example, the storage controller may determine whether to refer to the first mapping table for a write command that includes the instruction data and/or a write command received after a command that includes the instruction data. In some example embodiments, the storage controller may receive a separate command, which includes instruction data, from the host device. Some examples thereof are described below with reference to FIGS. 10 and 11.

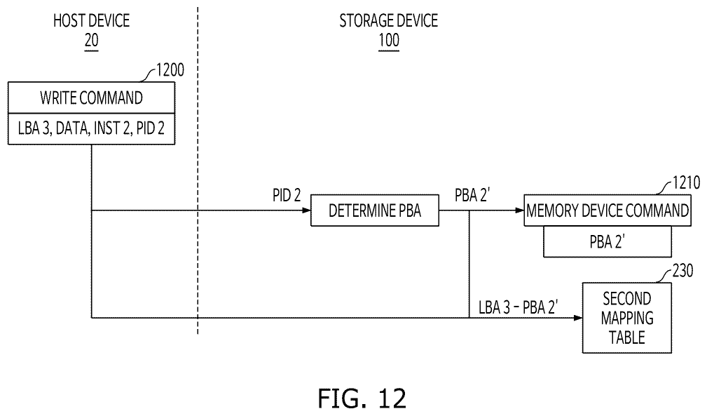

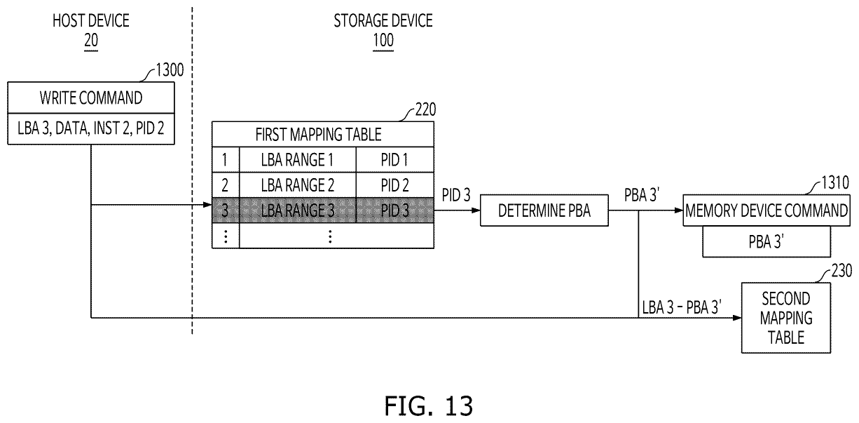

In some example embodiments, the write command may further include instruction data (e.g., a second type of instruction data) indicating whether to trust the placement identifier received from the host device. The storage controller may determine whether to trust the placement identifier received from the host device to perform the write command, based on the instruction data. For example, a storage controller may determine whether to trust a placement identifier received from a host device for a write command containing the instruction data and/or for a write command received subsequent to a command containing the instruction data. In some example embodiments, the storage controller may receive a separate command, which includes instruction data, from the host device. Some examples thereof are described below with reference to FIGS. 12 and 13.

The flowchart and description described above with reference to FIG. 8 are only examples and may be implemented differently in some example embodiments. For example, in some example embodiments, the order of each step may be changed, some steps may be repeated, some steps may be omitted, and/or some steps may be added.

FIG. 9 is a diagram illustrating an example of performing a write command 900 according to some example embodiments. The storage controller (e.g., storage controller 200 in FIG. 5) of the storage device 100 may receive a write command 900 from the host device 20. In some example embodiments, the write command 900 may include a logical block address LBA 3 and user data DATA associated with the logical block address LBA 3. For example, the user data DATA may refer to data to be stored in a memory device (e.g., memory device 300 in FIG. 5) of the storage device 100.

The storage controller (e.g., storage controller 200 in FIG. 5) may identify a placement identifier PID 3 corresponding to the logical block address LBA 3 based on the first mapping table 220. For example, the first mapping table 220 may include a plurality of entries in which mapping information between logical block addresses and placement identifiers is stored, and the logical block address stored in each of the plurality of entries may be expressed as a range of logical block addresses. In some example embodiments, the storage controller (e.g., storage controller 200 in FIG. 5) may identify a specific or alternatively, a desired entry (e.g., an entry with an identification number of 3) in which a range of logical block addresses (e.g., LBA RANGE 3), to which a logical block address LBA 3 belongs, is stored, and/or a placement identifier PID 3 corresponding to the logical block address LBA 3 stored in the specific or alternatively, desired entry.

Thereafter, the storage controller (e.g., storage controller 200 in FIG. 5) may determine the physical block address PBA 3′of the memory device (e.g., memory device 300 in FIG. 5) associated with the logical block address LBA 3 based on the placement identifier PID 3. In some example embodiments, the storage controller (e.g., storage controller 200 in FIG. 5) may determine the physical block address PBA 3′based on the logical block address LBA 3 and the placement identifier PID 3, but example embodiments are not limited thereto. In some example embodiments, the storage controller (e.g., storage controller 200 in FIG. 5) may determine the physical block address PBA 3′based on the logical block address LBA 3, the placement identifier PID 3, and a second mapping table 230.

Thereafter, the storage controller (e.g., storage controller 200 in FIG. 5) may transmit and/or send a memory device command 910, which instructs the memory device (e.g., memory device 300 in FIG. 5) to store user data DATA at the physical block address PBA 3′, to the memory device (e.g., memory device 300 in FIG. 5). The memory device (e.g., memory device 300 in FIG. 5) may receive the memory device command 910 and store the user data DATA in the physical block address PBA 3′. In some example embodiments, the storage controller (e.g., storage controller 200 in FIG. 5) may update mapping information between the logical block address LBA 3 and the physical block address PBA 3′in the second mapping table 230. In some example embodiments, the mapping information between the logical block address LBA 3 and the physical block address PBA 3′updated in the second mapping table 230 may be referenced by the storage controller (e.g., storage controller 200 in FIG. 5) when performing a read command to read the user data DATA.

FIG. 10 is a diagram illustrating an example of performing a write command 1000 according to some example embodiments. A storage controller (e.g., storage controller 200 in FIG. 5) of a storage device 100 may receive a write command 1000 from a host device 20. For example, the write command 1000 may include a logical block address LBA 3 and user data DATA associated with the logical block address LBA 3. In some example embodiments, the write command 1000 may further include instruction data INST 1 indicating whether to refer to the first mapping table 220.

The storage controller (e.g., storage controller 200 in FIG. 5) may determine whether to refer to the first mapping table 220 during the process of performing the write command 1000 based on the instruction data INST 1. FIG. 10 illustrates an example where the storage controller (e.g., storage controller 200 in FIG. 5) determines to refer to the first mapping table 220 during the process of performing the write command 1000.

For example, when it is determined to refer to the first mapping table 220, the storage controller (e.g., storage controller 200 in FIG. 5) may identify a placement identifier PID 3 corresponding to the logical block address LBA 3 based on the first mapping table 220. In some example embodiments, the storage controller (e.g., storage controller 200 in FIG. 5) may determine the physical block address PBA 3′of the memory device (e.g., memory device 300 in FIG. 5) associated with the logical block address LBA 3, based on the placement identifier PID 3.

In some example embodiments, the storage controller (e.g., storage controller 200 in FIG. 5) may send the memory device (e.g., memory device 300 in FIG. 5) command 1010, which instructs the memory device (e.g., memory device 300 in FIG. 5) to store the user data DATA at a physical block address PBA 3′, to the memory device (e.g., memory device 300 in FIG. 5). In some example embodiments, the storage controller (e.g., storage controller 200 in FIG. 5) may update mapping information between the logical block address LBA 3 and the physical block address PBA′ in the second mapping table 230.

In FIG. 10, the write command 1010 is illustrated as including a logical block address LBA 3, user data DATA, and instruction data INST 1, but example embodiments are not limited thereto. For example, in some example embodiments, the write command 1010 may include only a logical block address LBA 3 and user data DATA, and before the write command 1010 is received, a separate command including instruction data INST 1 may be received by the storage controller (e.g., storage controller 200 in FIG. 5). For example, the storage controller (e.g., storage controller 200 in FIG. 5) may determine whether to refer to the first mapping table 220 in the process of performing the write command 1010 and/or write commands received subsequently based on a separate command.

FIG. 11 is a diagram illustrating an example of performing a write command 1100 according to some example embodiments. In FIG. 11, descriptions overlapping with FIG. 10 are omitted.

A storage controller (e.g., storage controller 200 in FIG. 5) of a storage device 100 may receive a write command 1100 from a host device 20. For example, the write command 1100 may include a logical block address LBA 3, user data DATA, and instruction data INST 1. The storage controller (e.g., storage controller 200 in FIG. 5) may determine whether to refer to the first mapping table 220 during the process of performing the write command 1100 based on the instruction data INST 1. FIG. 11 shows an example where the storage controller (e.g., storage controller 200 in FIG. 5) determines not to reference the first mapping table 220 during the process of performing the write command 1110.

For example, if it is determined that the first mapping table 220 is not referenced, the storage controller (e.g., storage controller 200 in FIG. 5) may determine the physical block address PBA 3 of the memory device (e.g., memory device 300 in FIG. 5) corresponding to the logical block address LBA 3. For example, the storage controller (e.g., storage controller 200 in FIG. 5) may determine the physical block address PBA 3 of the memory device (e.g., memory device 300 in FIG. 5) based on the logical block address LBA 3 and the second mapping table 230. For example, the physical block address PBA 3 may be different from the physical block address PBA 3′of FIG. 10, but example embodiments are not limited thereto.

In some example embodiments, the storage controller (e.g., storage controller 200 in FIG. 5) may send a memory device command 1110, which instructs the memory device (e.g., memory device 300 in FIG. 5) to store user data DATA at a physical block address PBA 3, to the memory device (e.g., memory device 300 in FIG. 5). In some example embodiments, the storage controller (e.g., storage controller 200 in FIG. 5) may update mapping information between the logical block address LBA 3 and the physical block address PBA 3 in the second mapping table 230.

FIG. 12 is a diagram illustrating an example of performing a write command 1200 according to some example embodiments. A storage controller (e.g., storage controller 200 in FIG. 5) of a storage device 100 may receive a write command 1200 from a host device 20. For example, the write command 1200 may include a logical block address LBA 3 and user data DATA associated with the logical block address LBA 3. In some example embodiments, the write command 1200 may further include instruction data INST 2 and a placement identifier PID 2 indicating whether to trust the placement identifier received from the host device 20. For example, the placement identifier PID 2 may be a placement identifier specified by the host device 20 or specified by a device other than the storage device 100 and received from the host device 20.

The storage controller (e.g., storage controller 200 in FIG. 5) may determine whether to trust the placement identifier PID 2 received from the host device 20 based on the instruction data INST 2. FIG. 12 illustrates an example where the storage controller (e.g., storage controller 200 in FIG. 5) decides to trust a placement identifier PID 2 received from the host device 20 during the process of performing the write command 1200.

For example, if it is determined that the placement identifier PID 2 received from the host device 20 is trusted, the storage controller (e.g., storage controller 200 in FIG. 5) may determine the physical block address PBA′ of the memory device (e.g., memory device 300 in FIG. 5) associated with the logical block address LBA 3, based on the placement identifier PID 2. During this process, the storage controller (e.g., storage controller 200 in FIG. 5) may not reference a first mapping table. In some example embodiments, the storage controller (e.g., storage controller 200 in FIG. 5) may determine a physical block address PBA 2′based on a logical block address LBA 3 and a placement identifier PID 2, but example embodiments are not limited thereto.

In some example embodiments, the storage controller (e.g., storage controller 200 in FIG. 5) may send a memory device command 1210, which instructs the memory device (e.g., memory device 300 in FIG. 5) to store user data DATA at a physical block address PBA 2′, to the memory device (e.g., memory device 300 in FIG. 5). In some example embodiments, the storage controller (e.g., storage controller 200 in FIG. 5) may update mapping information between the logical block address LBA 3 and the physical block address PBA 2′in the second mapping table 230.

In FIG. 12, the write command 1210 is illustrated as including a logical block address LBA 3, user data DATA, instruction data INST 2, and a placement identifier PID 2, but example embodiments are not limited thereto. For example, in some example embodiments, the write command 1210 may include a logical block address LBA 3, user data DATA, and a placement identifier, and before the write command 1210 is received, a separate command including instruction data INST 2 may be received by the storage controller (e.g., storage controller 200 in FIG. 5). In some example embodiments, the storage controller (e.g., storage controller 200 in FIG. 5) may determine whether to trust the placement identifier received from the host device 20 in the process of performing the write command 1210 or write commands received later, based on a separate command.

FIG. 13 is a diagram illustrating an example of performing a write command 1300 according to some example embodiments. In FIG. 13, descriptions overlapping with FIG. 12 are omitted.

A storage controller (e.g., storage controller 200 in FIG. 5) of a storage device 100 may receive a write command 1300 from a host device 20. For example, the write command 1300 may include a logical block address LBA 3, user data DATA, instruction data INST 2, and placement identifier PID 2. The storage controller (e.g., storage controller 200 in FIG. 5) may determine whether to trust the placement identifier which is/was received from the host device 20 during the process of performing the write command 1300, based on the instruction data INST 2. FIG. 13 shows an example where the storage controller (e.g., storage controller 200 in FIG. 5) determines that the placement identifier PID 2 received from the host device 20 is not trusted during the process of performing the write command 1300.

For example, if it is determined that the placement identifier PID 2 received from the host device 20 is not trusted, the storage controller (e.g., storage controller 200 in FIG. 5) may identify the placement identifier PID 3 corresponding to the logical block address LBA 3, based on the first mapping table 220. In some example embodiments, based on the identified placement identifier PID 3, the storage controller (e.g., storage controller 200 in FIG. 5) may determine a physical block address PBA 3′ associated with the logical block address LBA 3 included in the write command 1300. For example, the storage controller (e.g., storage controller 200) may not reference the placement identifier PID 2 received from the host device 20. For example, the physical block address PBA 3′may be different from the physical block address PBA 2′of FIG. 12, but example embodiments are not limited thereto.

In some example embodiments, the storage controller (e.g., storage controller 200 in FIG. 5) may send a memory device command 1310, which instructs the memory device (e.g., memory device 300 in FIG. 5) to store user data DATA at a physical block address PBA 3′, to the memory device (e.g., memory device 300 in FIG. 5). In some example embodiments, the storage controller (e.g., storage controller 200 in FIG. 5) may update mapping information between the logical block address LBA 3 and the physical block address PBA 3′in the second mapping table 230.

In FIGS. 9 to 13, only some examples, in which the storage controller (e.g., storage controller 200 in FIG. 5) performs a write command based on one first mapping table (e.g., first mapping table 220), are described, but example embodiments of the present inventive concepts are not limited thereto, and as described above in some example embodiments, when the storage controller (e.g., storage controller 200 in FIG. 5) includes a plurality of namespaces, the storage controller (e.g., storage controller 200 in FIG. 5) may perform a write command based on the plurality of first mapping tables.

FIG. 14 is a flowchart illustrating an example of a method 1400 in which a table management command is performed according to some example embodiments. The method 1400 may be performed by a storage controller (e.g., a storage controller of a storage device). The method 1400 may be initiated by the storage controller receiving a table management command from a host device (S1410). The table management command may be a command for managing a first mapping table. The storage controller may perform a table management command to manage the first mapping table (S1420).

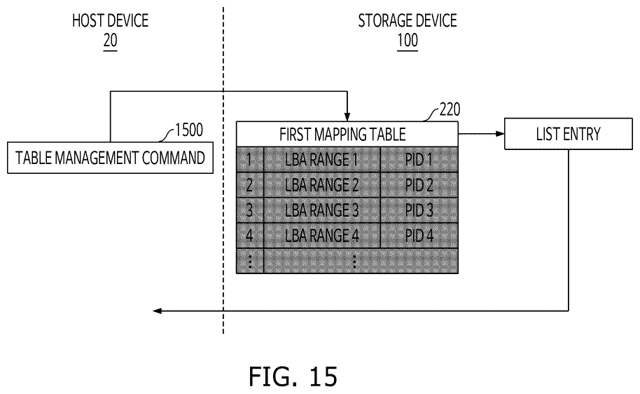

For example, the table management command may be a command that transmits and/or sends mapping information between logical block addresses and placement identifiers included in the first mapping table, to the host device. An example of such table management command is described below with reference to FIG. 15 according to some example embodiments.

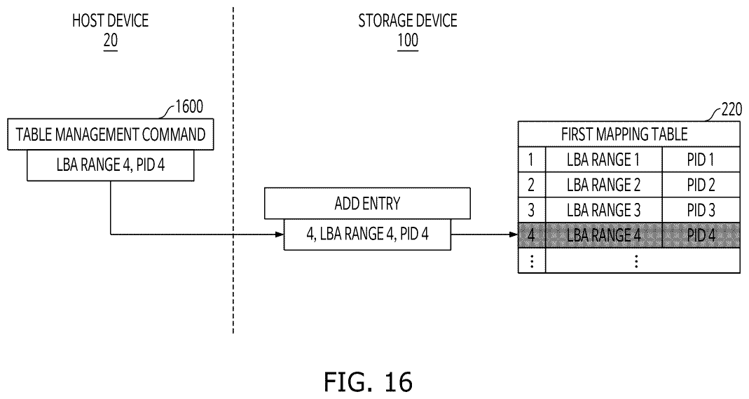

In some example embodiments, the table management command might be a command to add a specific or alternatively, a desired entry to the first mapping table. An example of such table management command is described below with reference to FIG. 16 according to some example embodiments.

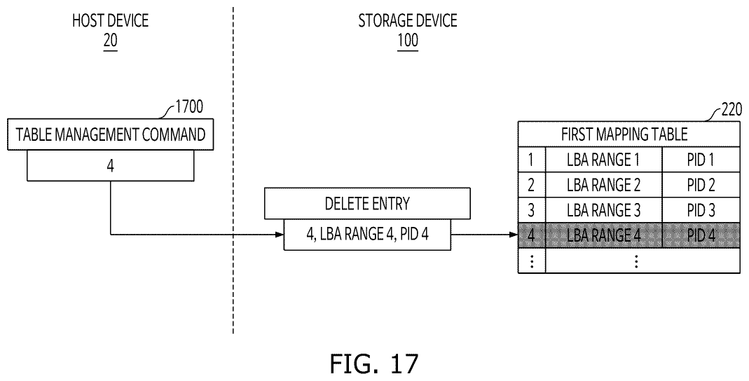

In some example embodiments, the table management command might be a command to delete a specific or alternatively, a desired entry contained in the first mapping table. An example of such table management command is described below with reference to FIG. 17 according to some example embodiments.

The flowchart and description described above using FIG. 14 are only some examples and may be implemented differently in some example embodiments. For example, in some example embodiments, the order of each step may be changed, some steps may be repeated, some steps may be omitted, and/or some steps may be added.

FIG. 15 is a diagram illustrating an example of performing a table management command 1500 according to some example embodiments. A storage controller (e.g., storage controller 200 in FIG. 5) of a storage device 100 may receive a table management command 1500 (e.g., a first table management command) for managing a first mapping table 220 from a host device 20.

In response to receiving the table management command 1500, the storage controller (e.g., storage controller 200 in FIG. 5) may transmit and/or send mapping information between logical block addresses and placement identifiers included in the first mapping table 220, to the host device 20. For example, the first mapping table 220 may include a plurality of entries, and each of the plurality of entries may store an identification number of the entry, a logical block address, and a placement identifier. The storage controller (e.g., storage controller 200 in FIG. 5) may transmit and/or send information about a plurality of entries included in the first mapping table 220, to the host device 20. In some example embodiments, the storage controller (e.g., storage controller 200 in FIG. 5) may transmit and/or send information about some of the entries specified by the host device 20, to the host device 20.

FIG. 16 is a diagram illustrating an example of performing a table management command 1600 according to some example embodiments. A storage controller (e.g., storage controller 200 in FIG. 5) may receive a table management command 1600 (e.g., a second table management command) for managing a first mapping table 220 from a host device 20. For example, the table management command 1600 may include a range of logical block addresses LBA RANGE 4 and a placement identifier PID 4 corresponding to the range of logical block addresses LBA RANGE 4. The table management command 1600 may be received after the table management command 1500 of FIG. 15 is performed (e.g., after mapping information between logical block addresses and placement identifiers included in the first mapping table 220) is transmitted and/or sent to the host device 20, but example embodiments are not limited thereto.

In response to receiving the table management command 1600, the storage controller (e.g., storage controller 200 in FIG. 5) may add an entry containing mapping information between a range of logical block addresses LBA RANGE 4 and a placement identifier PID 4, to the first mapping table 220. For example, in the process and/or operation of adding an entry to the first mapping table 220, an identification number 4 for identifying the entry may be assigned, but example embodiments are not limited thereto.

In some example embodiments, prior to performing the table management command 1600, the storage controller (e.g., storage controller 200 in FIG. 5) may verify whether an entry having a range of logical block addresses identical to the range of logical block addresses LBA RANGE 4 included in the table management command 1600 is stored in the first mapping table 220. In some example embodiments, if an entry having a range of logical block addresses identical to the range of logical block addresses LBA RANGE 4 included in the table management command 1600 is stored in the first mapping table 220, the storage controller (e.g., storage controller 200 in FIG. 5) may update the entry based on the range of logical block addresses LBA RANGE 4 and the placement identifier PID 4 included in the table management command 1600.

FIG. 17 is a diagram illustrating an example of performing a table management command 1700 according to some example embodiments. The storage controller (e.g., storage controller 200 in FIG. 5) may receive a table management command 1700 (e.g., a third table management command) for managing the first mapping table 220 from the host device 20. For example, the table management command 1700 may include data associated with a specific or alternatively, a desired entry. The table management command 1700 may be received after the table management command 1500 of FIG. 15 is performed (e.g., after mapping information between logical block addresses and placement identifiers included in the first mapping table 220 is transmitted and/or sent to the host device 20), but example embodiments are not limited thereto.

The storage controller (e.g., storage controller 200 in FIG. 5) may, in response to receiving a table management command 1700 containing data associated with the specific or alternatively, desired entry, delete the specific or alternatively, desired entry from the first mapping table 220. For example, the data associated with the specific or alternatively, desired entry may include at least one of an identification number 4 of the specific or alternatively, desired entry, a range of logical block addresses stored in the specific or alternatively, desired entry LBA RANGE 4, and a placement identifier PID 4 stored in the specific or alternatively, desired entry. For example, the storage controller (e.g., storage controller 200 in FIG. 5) may identify the specific or alternatively, desired entry from the first mapping table 220 and delete the identified specific or alternatively, desired entry from the first mapping table 220 based on at least one of an identification number 4 of the specific or alternatively, desired entry, a range of logical block addresses LBA RANGE 4 stored in the specific or alternatively desired entry, and a placement identifier PID 4 stored in the specific or alternatively, desired entry.

Examples of table management commands are not limited to the examples described in FIGS. 15 to 17, and, in some example embodiments, the storage controller may perform various table management commands for managing the first mapping table.

In FIGS. 15 to 17, only some example embodiments, in which the storage controller performs a table management command based on one first mapping table, have been described, but example embodiments of the present inventive concepts are not limited thereto, and as described above according to some example embodiments, when the storage controller includes a plurality of namespaces, the storage controller may perform a table management command based on a plurality of first mapping tables.

Accordingly, in some example embodiments, a storage device may optimize the storage pattern of user data stored in the storage device by performing various table management commands for managing a first mapping table including mapping information between logical block addresses and placement identifiers.

1. A storage device, comprising:
a memory device; and
a storage controller including a first mapping table and a second mapping table, the first mapping table including first mapping information between logical block addresses and placement identifiers, and the second mapping table including second mapping information between the logical block addresses and physical block addresses,
the storage controller configured to
receive a first command including a first logical block address from a host device,
identify a first placement identifier corresponding to the first logical block address based on the first mapping table,
determine a first physical block address of the memory device associated with the first logical block address based on the first placement identifier, and
update third mapping information between the first logical block address and the first physical block address in the second mapping table.

2. The storage device as claimed in claim 1, wherein
the first mapping table comprises a plurality of entries, the plurality of entries storing the first mapping information between the logical block addresses and the placement identifiers, and
ranges of the logical block addresses associated with each entry of the plurality of entries are different from each other.

3. The storage device as claimed in claim 2, wherein
the storage controller is further configured to receive a second command from the host device, and
the second command is a table management command for managing the first mapping table.

4. The storage device as claimed in claim 3, wherein the storage controller is further configured to send information associated with the plurality of entries comprised in the first mapping table, to the host device, in response to receiving the second command.

5. The storage device as claimed in claim 3, wherein
the second command comprises a second logical block address and a second placement identifier associated with the second logical block address, and
the storage controller is further configured to add a specific entry comprising fourth mapping information between the second logical block address and the second placement identifier to the first mapping table based on the second command.

6. The storage device as claimed in claim 3, wherein
the first mapping table comprises a specific entry, the specific entry storing fourth mapping information between a second logical block address and a second placement identifier,
the second command comprises data associated with the specific entry, and
the storage controller is further configured to delete the specific entry from the first mapping table based on the second command.

7. The storage device as claimed in claim 1, wherein the first command is a write command for storing user data in the memory device.

8. The storage device as claimed in claim 7, wherein
the first command further comprises instruction data, the instruction data indicating whether to refer to the first mapping table, and
the storage controller is further configured to determine whether to refer to the first mapping table to perform the first command, based on the instruction data.

9. The storage device as claimed in claim 8, wherein the storage controller is further configured to
identify the first placement identifier corresponding to the first logical block address based on the first mapping table in response to determining that the storage controller is to refer to the first mapping table, and
send a memory device command to the memory device, the memory device command instructing the memory device to store the user data at the first physical block address.

10. The storage device as claimed in claim 1, wherein
the storage controller is further configured to receive a second command from the host device,
the second command is a write command for storing user data in the memory device, the second command including a second logical block address and instruction data indicating whether to refer to the first mapping table, and
the storage controller is further configured to,
determine a second physical block address of the memory device corresponding to the second logical block address based on the second mapping table in response to determining that the first mapping table is not referenced; and
send a memory device command to the memory device, the memory device command instructing the memory device to store the user data at the second physical block address.

11. The storage device as claimed in claim 7, wherein
the first command comprises a second placement identifier and instruction data indicating whether to trust the placement identifiers received from the host device, and
the storage controller is further configured to determine whether to trust the second placement identifier received from the host device based on the instruction data.

12. The storage device as claimed in claim 11, wherein
the storage controller is further configured to,
identify the first placement identifier corresponding to the first logical block address based on the first mapping table in response to determining that the second placement identifier received from the host device is not trusted; and
send a memory device command to the memory device, the memory device command configured to instruct the memory device to store the user data at the first physical block address, and
the first placement identifier and the second placement identifier are different from each other.

13. The storage device as claimed in claim 1, wherein
the storage controller is further configured to receive a second command from the host device,
the second command is a write command for storing user data in the memory device, the second command including instruction data indicating whether to trust the placement identifiers received from the host device, a second logical block address, and a second placement identifier, and
the storage controller is further configured to,
determine whether to trust the second placement identifier received from the host device based on the instruction data;
determine a second physical block address of the memory device associated with the second logical block address based on the second placement identifier in response to determining to trust the second placement identifier received from the host device;
send a memory device command to the memory device, the memory device command instructing the memory device to store the user data at the second physical block address; and
update fourth mapping information between the second logical block address and the second physical block address in the second mapping table.

14. The storage device as claimed in claim 7, wherein the storage controller is further configured to send a memory device command to the memory device, the memory device command instructing the memory device to store the user data associated with the first command in the first physical block address of the memory device.

15. The storage device as claimed in claim 14, wherein the user data associated with the first command is stored in units of pages in a memory block corresponding to the first physical block address.

16. The storage device as claimed in claim 1, wherein
the storage controller is further configured to,
receive a second command from the host device; and
store, in a first memory block associated with the first placement identifier, first user data associated with the first command and second user data associated with the second command, and
the first user data associated with the first command has a first expected lifetime and the second user data associated with the second command has a second expected lifetime, the first expected lifetime and the second expected lifetime being within a same range.

17. The storage device as claimed in claim 16, wherein
the storage controller is further configured to,
receive a third command from the host device; and
store, in a second memory block associated with a second placement identifier that is different from the first placement identifier, third user data associated with the third command, and
the third user data associated with the third command has a third expected lifetime and the first user data associated with the first command has the first expected lifetime, the first expected lifetime and the third expected lifetime falling within different ranges.

18. A method of operating a storage device, the method comprising:
receiving, by a storage controller, a first command including a first logical block address from a host device;
identifying, by the storage controller, a first placement identifier corresponding to the first logical block address based on a first mapping table including first mapping information between logical block addresses and placement identifiers;
determining, by the storage controller, a first physical block address of a memory device associated with the first logical block address based on the first placement identifier; and
updating, by the storage controller, second mapping information between the first logical block address and the first physical block address in a second mapping table that includes third mapping information between the logical block addresses and physical block addresses.

19. The method as claimed in claim 18, further comprising:
receiving, by the storage controller, a second command from the host device, the second command being a table management command for managing the first mapping table; and
sending, by the storage controller, information associated with a plurality of entries comprised in the first mapping table to the host device in response to receiving the second command.

20. A storage system, comprising:
a host device; and
a storage device configured to perform a command received from the host device, the storage device including,
a memory device; and
a storage controller including a first mapping table and a second mapping table, the first mapping table including first mapping information between logical block addresses and placement identifiers, and the second mapping table including second mapping information between the logical block addresses and physical block addresses,
the storage controller is configured to
receive a first command including a first logical block address from the host device,
identify a first placement identifier corresponding to the first logical block address based on the first mapping table,
determine a first physical block address of the memory device associated with the first logical block address based on the first placement identifier, and
update third mapping information between the first logical block address and the first physical block address in the second mapping table.
